(19) United States
(12) Patent Application Publication
(10) Pub. No.: US 2026/0200404 A1
(43) Pub. Date: Jul. 16, 2026

(54) DETACHABLE TRAILER ATTACHMENT

(71) Applicant: TNT STEP LLC, Windsor, OH (US)

(72) Inventor: Tim G. BURLINSKI, Windsor, OH (US)

(21) Appl. No.: 19/017,033

(22) Filed: Jan. 10, 2025

(51) Int. Cl. B60R 3/00

(52) U.S. Cl. CPC B60R 3/007

(57) ABSTRACT

A detachable trailer attachment comprising a pair of opposing side members extending from a bottom section to a top section, a plurality of step members substantially perpendicularly extending between and secured to the pair of opposing side members, wherein the plurality of step members comprise a top step member extending beyond the back portion of each of the pair of opposing side members, wherein a tab is positioned on a bottom portion of the top step member, wherein the tab is configured to be removably inserted into an opening on the trailer bed, and wherein the top step member is positioned in substantially the same horizontal plane as a trailer bed in use and provides a work platform positioned off a side of the trailer bed and configured to support the weight of a user.

### TECHNICAL FIELD

The present disclosure relates to a detachable trailer attachment and flatbed trailers incorporating the same.

### BACKGROUND

Commercial truckers frequently encounter situations in which they need to access an elevated flatbed trailer. The greatest likelihood of injury to a truck driver occurs during ascent to and descent from the elevated bed of a trailer. These injuries often occur because most truck drivers hoist themselves up to the elevated bed by hand and get down from the elevated trailer by jumping to the ground. Such practices often result in bodily injuries such as broken bones, pulled muscles, sprained ankles, as well as cuts, scrapes, bruises and other such injuries. There exists a continuing need for new and improved detachable trailer attachments configured to assist a person in safely and quickly ascending and descending a flatbed trailer or truck.

### SUMMARY

In one embodiment, disclosed is a detachable trailer attachment comprising a pair of opposing side members extending from a bottom section to a top section, wherein each of the pair of opposing side members comprises (i) a back portion configured to be positioned adjacent to a trailer bed, (ii) a front portion, (iii) an inner side wall, and (iv) an outer side wall; a plurality of step members substantially perpendicularly extending between and secured to the inner side walls of each of the pair of opposing side members, wherein the plurality of step members comprise a top step member positioned in the same horizontal plane as the top section of each of the pair of opposing side members, wherein the top step member extends beyond the back portion of each of the pair of opposing side members, wherein a tab is positioned on a bottom portion of the top step member that extends beyond the back portion of each of the pair of opposing side members, wherein the tab is configured to be removably inserted into an opening on the trailer bed, and wherein the top step member is positioned in substantially the same horizontal plane as the trailer bed in use and provides a work platform positioned off a side of the trailer bed and configured to support the weight of a user.

Also disclosed is a flat-bed trailer comprising at least one opening positioned on an outer peripheral edge of the trailer and a detachable trailer attachment comprising a pair of opposing side members extending from a bottom section to a top section, wherein each of the pair of opposing side members comprises (i) a back portion configured to be positioned adjacent to a trailer bed, (ii) a front portion, (iii) an inner side wall, and (iv) an outer side wall; a plurality of step members substantially perpendicularly extending between and secured to the inner side walls of each of the pair of opposing side members, wherein the plurality of step members comprise a top step member positioned in the same horizontal plane as the top section of each of the pair of opposing side members, wherein the top step member extends beyond the back portion of each of the pair of opposing side members, wherein a tab is positioned on a bottom portion of the top step member that extends beyond the back portion of each of the pair of opposing side members, wherein the tab is configured to be removably inserted into an opening on the trailer bed, and wherein the top step member is positioned in substantially the same horizontal plane as the trailer bed in use and provides a work platform positioned off a side of the trailer bed and configured to support the weight of a user, wherein the tab positioned on the bottom portion of the top step member of the detachable trailer attachment is inserted into the at least one opening positioned on the outer peripheral edge of the trailer.

Also disclosed is a method for assisting a person in ascending and descending a flatbed trailer or truck, the method comprises attaching a detachable trailer attachment comprising a pair of opposing side members extending from a bottom section to a top section, wherein each of the pair of opposing side members comprises (i) a back portion configured to be positioned adjacent to a trailer bed, (ii) a front portion, (iii) an inner side wall, and (iv) an outer side wall; a plurality of step members substantially perpendicularly extending between and secured to the inner side walls of each of the pair of opposing side members, wherein the plurality of step members comprise a top step member positioned in the same horizontal plane as the top section of each of the pair of opposing side members, wherein the top step member extends beyond the back portion of each of the pair of opposing side members, wherein a tab is positioned on a bottom portion of the top step member that extends beyond the back portion of each of the pair of opposing side members, wherein the tab is configured to be removably inserted into an opening on the trailer bed, and wherein the top step member is positioned in substantially the same horizontal plane as the trailer bed in use and provides a work platform positioned off a side of the trailer bed and configured to support the weight of a user, to an outer peripheral edge of the flatbed trailer or truck.

### BRIEF DESCRIPTION OF THE DRAWINGS

FIG. 1 is a front top perspective view of an illustrative detachable trailer attachment.

FIG. 2 is a back rear perspective view of the detachable trailer attachment of FIG. 1.

FIG. 3 is a side perspective view of an illustrative detachable trailer attachment removably attached to trailer bed.

FIG. 4 is a front side perspective view of an illustrative detachable trailer attachment removably attached to trailer bed.

FIG. 5 is a front perspective view of an illustrative detachable trailer attachment removably attached to a sloping trailer bed.

FIG. 6 is a front top perspective view of an illustrative partially disassembled detachable trailer attachment.

FIG. 7 is a side perspective view of illustrative handrail members having handles removably secured thereto.

### DETAILED DESCRIPTION

According to certain embodiments, disclosed is a detachable trailer attachment comprising a pair of opposing side members extending from a bottom section to a top section, wherein each of the pair of opposing side members comprises (i) a back portion configured to be positioned adjacent to a trailer bed, (ii) a front portion, (iii) an inner side wall, and (iv) an outer side wall.

The detachable trailer attachment further comprises a plurality of step members substantially perpendicularly extending between and secured to the inner side walls of each of the pair of opposing side members. According to certain embodiments, the plurality of step members comprise a top step member positioned in the same horizontal plane as the top section of each of the pair of opposing side members.

The top step member extends beyond the back portion of each of the pair of opposing side members. A tab is positioned on a bottom portion of the top step member that extends beyond the back portion of each of the pair of opposing side members. The tab is configured to be removably inserted into an opening on a trailer bed. According to certain illustrative embodiments, the top step member is positioned in substantially the same horizontal plane as the trailer bed in use and provides a work platform positioned off a side of the trailer bed and configured to support the weight of a user.

According to certain embodiments, the tab is positioned centrally on the bottom portion of the top step member that extends beyond the back portion of each of the pair of opposing side members.

According to certain embodiments, the width of the bottom section of the pair of opposing side members is greater than the width of the top section of the pair of opposing side members.

According to certain embodiments, the tab is not configured to be removably inserted between the trailer bed and a rail spaced therefrom. Rather, the tab is configured to be removably inserted into an opening on a trailer bed.

According to certain embodiments, the plurality of step members are substantially planar. According to certain embodiments, the detachable trailer attachment is a single integral structure. The detachable trailer attachment may be fabricated from steel, aluminum, or other suitable structural materials. If weldable metals are used, the pieces may be cut, fitted, and joined together by welding to form a single welded unit.

According to certain embodiments, the detachable trailer attachment comprises a slot on a portion of the outer side wall of the top section of each of the pair of opposing side members, wherein the slot is configured to accept a handrail member to assist a user moving up and down the detachable trailer attachment. In certain embodiments, a top portion of the slot is in the same plane as the top step member of the detachable trailer attachment. In some cases, the slot is configured to accept 2x4 dimensional lumber. In some cases, the slot is configured to accept a metal, for example, aluminum, stake. In some cases, the slot is configured to accept a metal, for example, aluminum, stake. The handrail members may be composed of the same or different material, and additionally may have the same or different dimensions. In some cases, the handrail member has four sides. According to this embodiment, the handrail member may have two sides of approximately 3 inches and the remaining two sides may have a dimension of approximately 1.5 inches. In some cases, the handrail members have a length of at least 25 inches, or at least 26 inches , or at least 27 inches, or at least 28 inches, or at least 29 inches, or at least 30 inches, or at least 31 inches. In certain embodiments, the handrail member extends at least 25 inches, or at least 26 inches, or at least 27 inches, or at least 28 inches above the top step of the detachable trailer attachment. In some embodiments, a handle is removably secured, for example, by bolts, screws, or other known means, to one or more of the handrail member.

Also disclosed is a kit comprising the components of any of the disclosed embodiments of the detachable trailer attachment. The detachable trailer attachment kit can be assembled by a third party different from the manufacturer. In certain embodiments, the detachable trailer attachment kit comprises the following separate components: i) opposing side members, ii) a plurality of step members, iii) slot members to be secured to portion of outer side wall of the opposing side members; iv) handrail members configured to be inserted into slot members; v) first handle members configured to be secured to handrail members; and vi) second handle members configured to be secured to portion of outer side wall of the opposing side members. The separate components may be assembled by bolts, screws, or other known affixing means.

In certain embodiments, detachable trailer attachment further comprises a stirrup step member that is positioned below the bottom step of the detachable trailer attachment. In some embodiments, the stirrup step member is positioned substantially adjacent to the bottom step of the detachable trailer attachment when the stirrup step member is in a retracted position, and further capable of extending to a position substantially below the bottom step of the detachable trailer attachment.

According to certain embodiments, the back portion of each of the pair of opposing side members of the detachable trailer attachment is substantially planar.

According to certain embodiments, the front portion of each of the pair of opposing side members of the detachable trailer attachment is sloping from the bottom section to the top section of each of the pair of opposing side members. In some cases, the sloping front portion of each of the pair of opposing side members is less than 50 degrees relative to the longitudinal axis of the side members.

According to certain embodiments, the plurality of step members of the detachable trailer attachment do not extend beyond the front portion of the side members.

Also disclosed is a flat-bed trailer comprising at least one opening positioned on an outer peripheral edge of the trailer and the disclosed detachable trailer attachment, wherein the tab positioned on the bottom portion of the top step member of the detachable trailer attachment is inserted into the at least one opening positioned on the outer peripheral edge of the trailer.

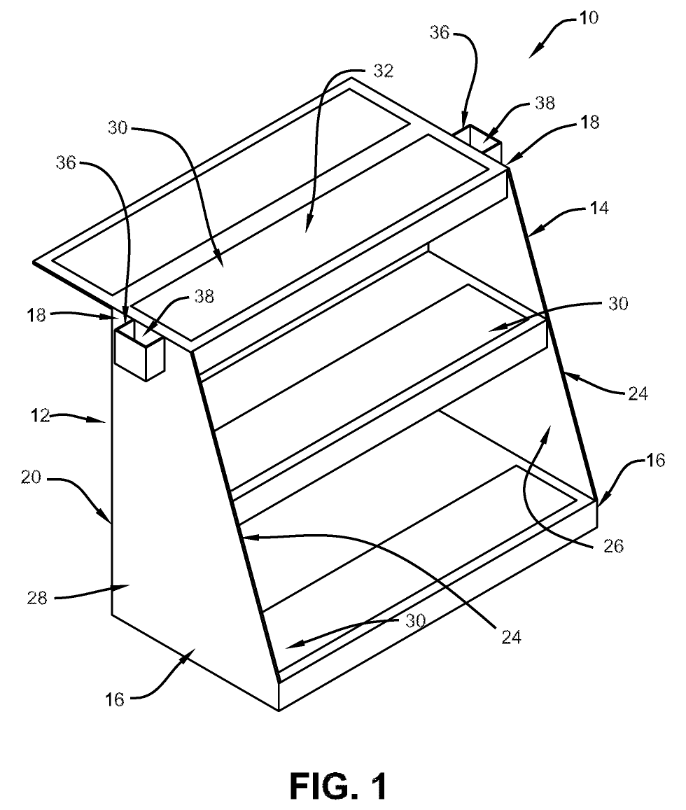

The disclosed detachable trailer attachment is readily understood when read in conjunction with illustrative FIGS. 1-5. It should be noted that the detachable trailer attachment is not limited to any of the illustrative embodiments shown in the figures, but rather should be construed in breadth and scope in accordance with the disclosure provided herein.

FIG. 1 is a front top perspective view of an illustrative detachable trailer attachment 10 comprising a pair of opposing side members 12, 14 extending from bottom section 16 to top section 18, wherein each of the pair of opposing side members 12, 14 comprises back portion 20 configured to be positioned adjacent to trailer bed (not shown), front portion 24, inner side wall 26, and outer side wall 28; plurality of step members 30 substantially perpendicularly extending between and secured to the inner side walls 26 of each of the pair of opposing side members 12, 14, wherein plurality of step members 30 comprise top step member 32 positioned in the same horizontal plane as top section 18 of each of the pair of opposing side members 12, 14, wherein top step member 32 extends beyond back portion 20 of each of the pair of opposing side members 12, 14, wherein tab (not shown) is positioned on bottom portion (not shown) of top step member 32 that extends beyond back portion 20 of each of the pair of opposing side members 12, 14, wherein tab (not shown) is configured to be removably inserted into opening (not shown) on trailer bed (not shown), wherein slot 36 is positioned on portion of outer side wall 28 of top section 18 of each of the pair of opposing side members 12, 14, wherein top portion 38 of slot 36 is in the same horizontal plane as top step member 32, and wherein slot 36 is configured to accept a handrail member, such as 2x4 dimensional lumber, to assist a user moving up and down detachable trailer attachment 10.

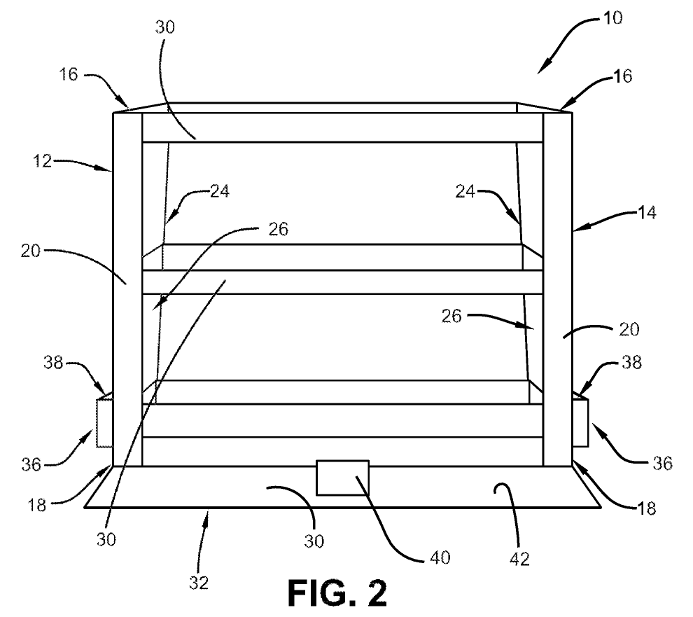

FIG. 2 is a back rear perspective view of an illustrative detachable trailer attachment 10 comprising a pair of opposing side members 12, 14 extending from bottom section 16 to top section 18, wherein each of the pair of opposing side members 12, 14 comprises back portion 20 configured to be positioned adjacent to trailer bed (not shown), front portion 24, inner side wall 26, and outer side wall 28; plurality of step members 30 substantially perpendicularly extending between and secured to the inner side walls 26 of each of the pair of opposing side members 12, 14, wherein plurality of step members 30 comprise top step member 32 positioned in the same horizontal plane as top section 18 of each of the pair of opposing side members 12, 14, wherein top step member 32 extends beyond back portion 20 of each of the pair of opposing side members 12, 14, wherein tab 40 is positioned on bottom portion 42 of top step member 32 that extends beyond back portion 20 of each of the pair of opposing side members 12, 14, wherein tab 40 is configured to be removably inserted into opening (not shown) on trailer bed (not shown), wherein slot 36 is positioned on portion of outer side wall 28 of top section 18 of each of the pair of opposing side members 12, 14, wherein top portion 38 of slot 36 is in the same horizontal plane as top step member 32, and wherein slot 36 is configured to accept a handrail member, such as 2x4 dimensional lumber, to assist a user moving up and down detachable trailer attachment 10.

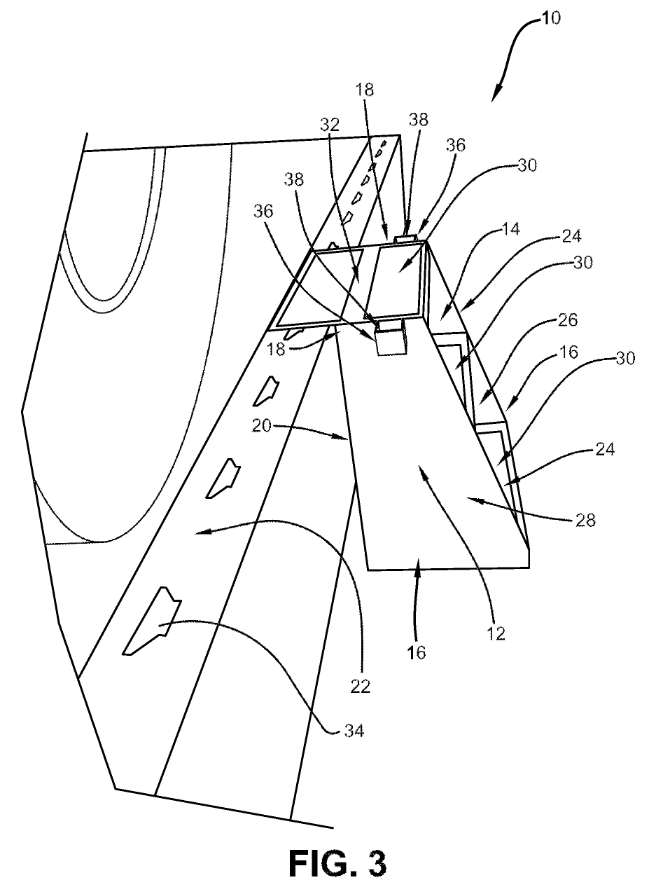

FIG. 3 is a side perspective view of an illustrative detachable trailer attachment 10 removably attached to trailer bed 22, wherein detachable trailer attachment 10 comprises a pair of opposing side members 12, 14 extending from bottom section 16 to top section 18, wherein each of the pair of opposing side members 12, 14 comprises back portion 20 configured to be positioned adjacent to trailer bed 22, front portion 24, inner side wall 26, and outer side wall 28; plurality of step members 30 substantially perpendicularly extending between and secured to the inner side walls 26 of each of the pair of opposing side members 12, 14, wherein plurality of step members 30 comprise top step member 32 positioned in the same horizontal plane as top section 18 of each of the pair of opposing side members 12, 14, wherein top step member 32 extends beyond back portion 20 of each of the pair of opposing side members 12, 14, wherein tab (not shown) is positioned on bottom portion (not shown) of top step member 32 that extends beyond back portion 20 of each of the pair of opposing side members 12, 14, wherein tab (not shown) is configured to be removably inserted into opening 34 on trailer bed 22, wherein top step member 32 is positioned in substantially the same horizontal plane as trailer bed 22 in use and provides a work platform positioned off a side of trailer bed 22 and configured to support the weight of a user, wherein slot 36 is positioned on portion of outer side wall 28 of top section 18 of each of the pair of opposing side members 12, 14, wherein top portion 38 of slot 36 is in the same horizontal plane as top step member 32, and wherein slot 36 is configured to accept a handrail member (not shown), such as 2x4 dimensional lumber, to assist a user moving up and down detachable trailer attachment 10.

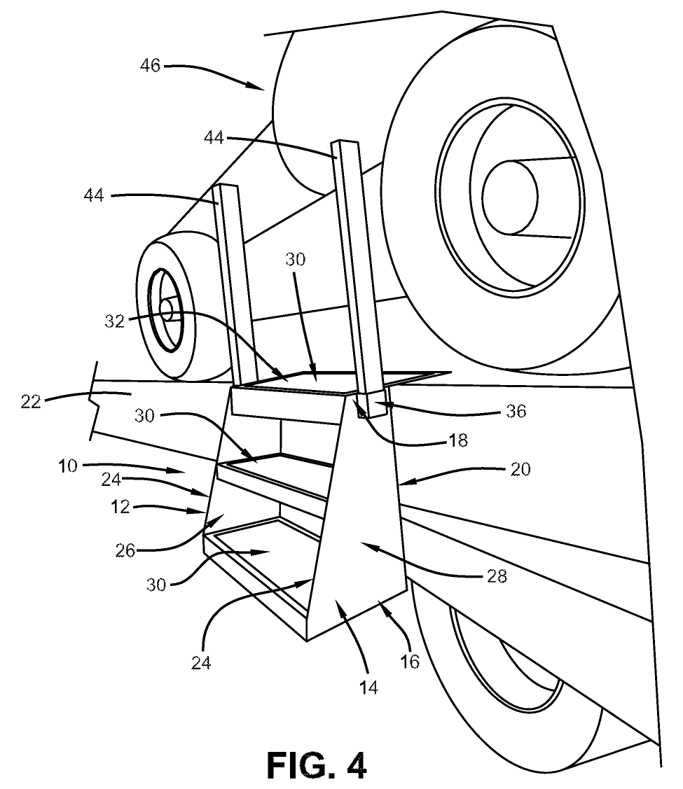

FIG. 4 is a front side perspective view of an illustrative detachable trailer attachment 10 removably attached to trailer bed 22, wherein detachable trailer attachment 10 comprises a pair of opposing side members 12, 14 extending from bottom section 16 to top section 18, wherein each of the pair of opposing side members 12, 14 comprises back portion 20 configured to be positioned adjacent to trailer bed 22, front portion 24, inner side wall 26, and outer side wall 28; plurality of step members 30 substantially perpendicularly extending between and secured to the inner side walls 26 of each of the pair of opposing side members 12, 14, wherein plurality of step members 30 comprise top step member 32 positioned in the same horizontal plane as top section 18 of each of the pair of opposing side members 12, 14, wherein top step member 32 extends beyond back portion 20 of each of the pair of opposing side members 12, 14, wherein tab (not shown) is positioned on bottom portion (not shown) of top step member 32 that extends beyond back portion 20 of each of the pair of opposing side members 12, 14, wherein tab (not shown) is configured to be removably inserted into opening 34 on trailer bed 22, wherein top step member 32 is positioned in substantially the same horizontal plane as trailer bed 22 in use and provides a work platform positioned off a side of trailer bed 22 and configured to support the weight of a user, wherein piece of equipment 46 such as a construction vehicle is loaded on top of trailer bed 22, wherein slot 36 is positioned on portion of outer side wall 28 of top section 18 of each of the pair of opposing side members 12, 14, and wherein slot 36 is configured to accept a handrail member 44, such as 2x4 dimensional lumber, to assist a user moving up and down detachable trailer attachment 10.

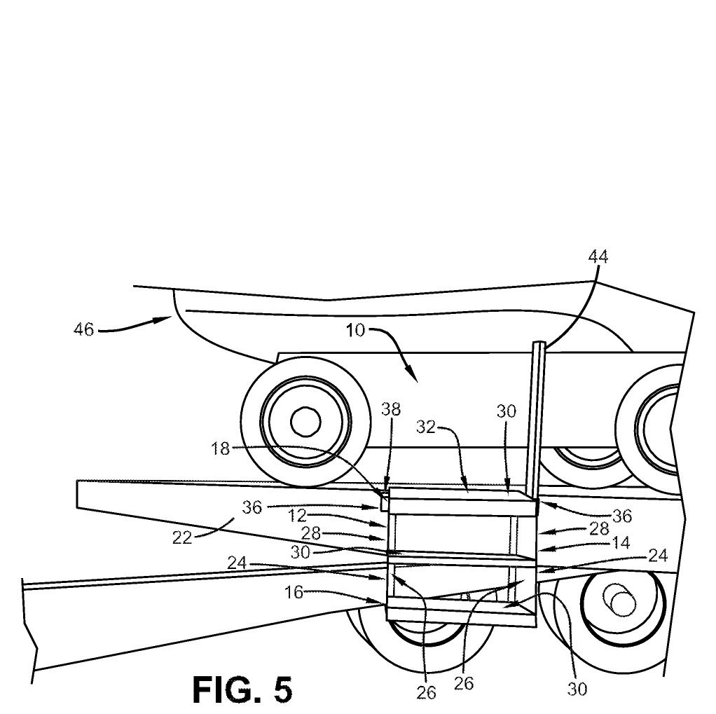

FIG. 5 is a front perspective view of an illustrative detachable trailer attachment 10 removably attached to trailer bed 22, wherein detachable trailer attachment 10 comprises a pair of opposing side members 12, 14 extending from bottom section 16 to top section 18, wherein each of the pair of opposing side members 12, 14 comprises back portion (not shown) configured to be positioned adjacent to trailer bed 22, front portion 24, inner side wall 26, and outer side wall 28; plurality of step members 30 substantially perpendicularly extending between and secured to the inner side walls 26 of each of the pair of opposing side members 12, 14, wherein plurality of step members 30 comprise top step member 32 positioned in the same horizontal plane as top section 18 of each of the pair of opposing side members 12, 14, wherein top step member 32 extends beyond back portion 20 of each of the pair of opposing side members 12, 14, wherein tab (not shown) is positioned on bottom portion (not shown) of top step member 32 that extends beyond back portion 20 of each of the pair of opposing side members 12, 14, wherein tab (not shown) is configured to be removably inserted into opening (not shown) on trailer bed 22, wherein top step member 32 is positioned in substantially the same horizontal plane as trailer bed 22 in use and provides a work platform positioned off a side of trailer bed 22 and configured to support the weight of a user, wherein piece of equipment 46 such as a construction vehicle is loaded on top of trailer bed 22, wherein slot 36 is positioned on portion of outer side wall 28 of top section 18 of each of the pair of opposing side members 12, 14, wherein top portion 38 of slot 36 is in the same horizontal plane as top step member 32, and wherein slot 36 is configured to accept a handrail member 44, such as 2x4 dimensional lumber, to assist a user moving up and down detachable trailer attachment 10.

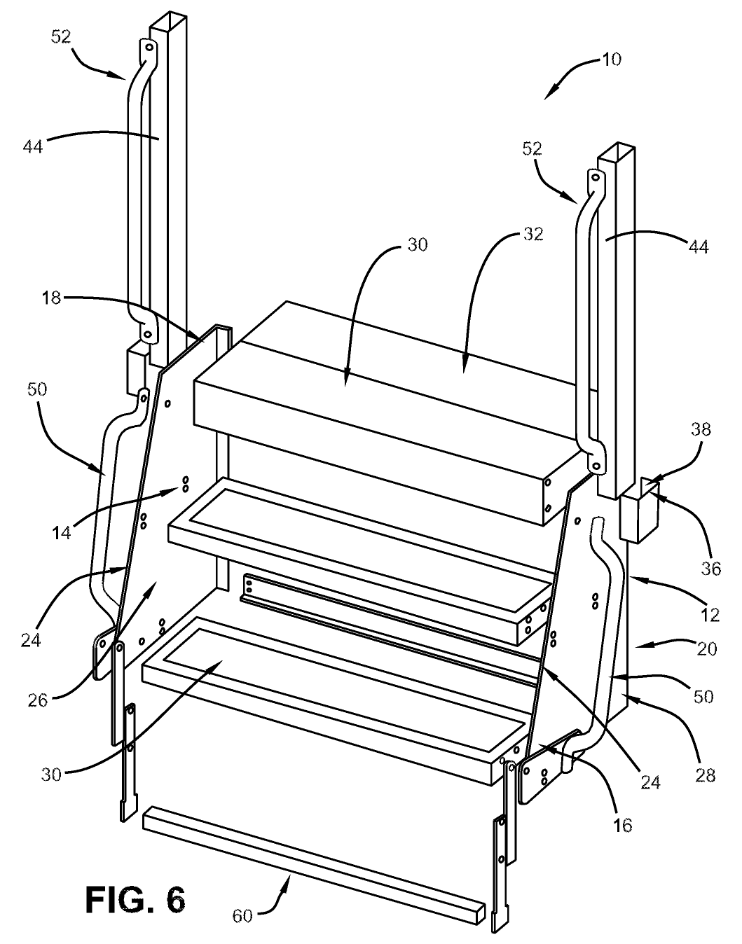

FIG. 6 is a front top perspective view of an illustrative partially disassembled detachable trailer attachment 10 comprising a pair of opposing side members 12, 14 extending from bottom section 16 to top section 18, wherein each of the pair of opposing side members 12, 14 comprises back portion 20 configured to be positioned adjacent to trailer bed (not shown), front portion 24, inner side wall 26, and outer side wall 28; plurality of step members 30 substantially perpendicularly extending between and secured to the inner side walls 26 of each of the pair of opposing side members 12, 14, wherein plurality of step members 30 comprise top step member 32 positioned in the same horizontal plane as top section 18 of each of the pair of opposing side members 12, 14, wherein top step member 32 extends beyond back portion 20 of each of the pair of opposing side members 12, 14, wherein tab (not shown) is positioned on bottom portion (not shown) of top step member 32 that extends beyond back portion 20 of each of the pair of opposing side members 12, 14, wherein tab (not shown) is configured to be removably inserted into opening (not shown) on trailer bed (not shown), wherein slot 36 is positioned on portion of outer side wall 28 of top section 18 of each of the pair of opposing side members 12, 14, and wherein slot 36 is configured to accept a handrail member 44, such as metal, for example, aluminum stakes, to assist a user moving up and down detachable trailer attachment 10, wherein the handrail member includes a handle 52 removably secured thereto, wherein stirrup step 60 is positioned below bottom step 30 of the detachable trailer attachment 10.

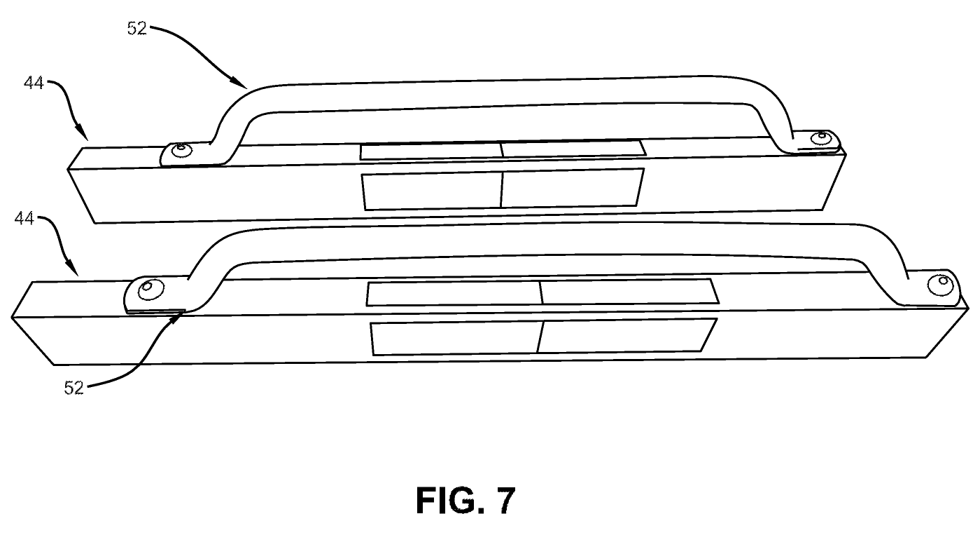

FIG. 7 is a side perspective view of illustrative handrail members 44 having handle 52 removably secured thereto, wherein handrail members 44 are configured to be removably inserted into slots 36 of detachable trailer attachment 10

While the detachable trailer attachment has been disclosed according to certain embodiments, it is to be understood that other similar embodiments may be used or modifications and additions may be made to the described embodiments for performing the same function. Furthermore, the various illustrative embodiments may be combined to produce the desired results. Therefore, the present disclosure should not be limited to any single embodiment.

As used in this specification, the terms "comprises," "comprising," “contains,” “containing,” "includes," "including," "has," or "having," are all open-ended expressions and are intended to cover apparatus, compositions, methods, processes, products, or systems that comprise a recited list of components, elements, and features, and any and all additional components, elements and features that are not expressly recited. The terms "includes," "including," "has," or "having" are not intended to have a more narrow construction, interpretation, or meaning than the terms “comprises” or “comprising.”

In the present disclosure, the term "substantially" refers to a degree of deviation that is sufficiently small so as to not measurably detract from the identified property or function or circumstance and/or refer to slight variations within normal manufacturing tolerances.

As used in the present specification, the term "or" refers to an inclusive “or” and not to an exclusive “or”. For example, the phrase “A or B” is satisfied by any one of the following: A is present and B is not present, A is not present and B is present, and both A and B are present.

As used in the present specification, "a" or "an" is employed to describe components, elements, features and method/process steps of various illustrative embodiments disclosed herein. The use of “a” or “an” should be interpreted to include one or more than one.

As used in the present specification, any of the terms “illustratively,” "preferably," "commonly," and "typically" are not intended to, and do not, limit the scope of the claimed embodiments, or to imply that certain features are critical, essential, important, or required to the structure or function of the claimed composition, beverage product or methods. Rather, these terms are merely intended to identify particular aspects of an embodiment or to emphasize alternative or additional features that may or may not be utilized in a particular embodiment.

1. A detachable trailer attachment comprising:
a pair of opposing side members extending from a bottom section to a top section, wherein each of the pair of opposing side members comprises (i) a back portion configured to be positioned adjacent to a trailer bed, (ii) a front portion, (iii) an inner side wall, and (iv) an outer side wall;
a plurality of step members substantially perpendicularly extending between and secured to the inner side walls of each of the pair of opposing side members, wherein the plurality of step members comprise a top step member positioned in the same horizontal plane as the top section of each of the pair of opposing side members, wherein the top step member extends beyond the back portion of each of the pair of opposing side members, wherein a tab is positioned on a bottom portion of the top step member that extends beyond the back portion of each of the pair of opposing side members, wherein the tab is configured to be removably inserted into an opening on the trailer bed, and wherein the top step member is positioned in substantially the same horizontal plane as the trailer bed in use and provides a work platform positioned off a side of the trailer bed and configured to support the weight of a user.

2. The detachable trailer attachment of claim 1, wherein the tab is positioned centrally on the bottom portion of the top step member that extends beyond the back portion of each of the pair of opposing side members.

3. The detachable trailer attachment of claim 1, wherein the width of the bottom section of the pair of opposing side members is greater than the width of the top section of the pair of opposing side members.

4. The detachable trailer attachment of claim 1, wherein the tab is not configured to be removably inserted between the trailer bed and a rail spaced therefrom.

5. The detachable trailer attachment of claim 1, wherein the plurality of step members are substantially planar.

6. The detachable trailer attachment of claim 1, wherein the detachable trailer attachment is a single integral structure.

7. The detachable trailer attachment of claim 1 further comprising a slot on a portion of the outer side wall of the top section of each of the pair of opposing side members, wherein the slot is configured to accept a handrail member to assist a user moving up and down the detachable trailer attachment.

8. The detachable trailer attachment of claim 7, wherein a top portion of the slot is in the same plane as the top step member.

9. The detachable trailer attachment of claim 7, wherein the slot is configured to accept 2x4 dimensional lumber.

10. The detachable trailer attachment of claim 1, wherein the back portion of each of the pair of opposing side members is substantially planar.

11. The detachable trailer attachment of claim 1, wherein the front portion of each of the pair of opposing side members is sloping from the bottom section to the top section of each of the pair of opposing side members.

12. The detachable trailer attachment of claim 1, wherein the sloping front portion of each of the pair of opposing side members is less than 50 degrees relative to the longitudinal axis of the side members.

13. The detachable trailer attachment of claim 1, wherein the plurality of step members do not extend beyond the front portion of the side members.

14. A flat-bed trailer comprising at least one opening positioned on an outer peripheral edge of the trailer and the detachable trailer attachment of claim 1, wherein the tab positioned on the bottom portion of the top step member of the detachable trailer attachment is inserted into the at least one opening positioned on the outer peripheral edge of the trailer.
